(19) United States
(12) Patent Application Publication
(10) Pub. No.: US 2009/0249234 A1
(43) Pub. Date: Oct. 1, 2009

(54) SYSTEM AND METHOD FOR EFFICIENTLY DISPLAYING SCORE INFORMATION RELATED TO ENTITIES

(76) Inventors: Ran Zilca, Briarcliff Manor, NY (US); Giri Iyengar, Nanuet, NY (US); David Markowitz, New York, NY (US); David Rosen, Brooklyn, NY (US); Ron Mackley, Garwood, NJ (US); Ryan Osborn, Hoboken, NJ (US); Garrett Snider, Germantown, MD (US); Andrea Rosengren, Stockholm (SE); Karen McGrane, New York, NY (US); Jonathan Greacen, Brooklyn, NY (US); Jenny Ng, Hoboken, NJ (US); Lewis Robert Goldberg, Eugene, OR (US); Daniel J. Levitin, Montreal (CA); Peter Jason Rentfrow, Cambridge (GB)

Correspondence Address: KEUSEY, TUTUNJIAN & BITETTO, P.C., 20 CROSSWAYS PARK NORTH, SUITE 210, WOODBURY, NY, 11797, US

(21) Appl. No.: 12/060,357

(22) Filed: Apr. 1, 2008

(51) Int. Cl. G06F 3/048

(52) U.S. Cl. 715/765

(57) ABSTRACT

A system and method for graphically presenting profile data includes providing a plurality of fields on a display, each field representing a different trait. The fields are populated with a representative shape. Each shape represents a trait or sub trait where the shape represents a magnitude of the trait or sub trait. The traits and sub traits collectively provide an entity profile. Graphic modification to the representative shape permits a comparison with another entity profile with graphically depicted traits in accordance with the graphic modification.

### BACKGROUND

1. Technical Field

The present invention relates to human/computer interfaces, and more particularly to systems and methods for displaying information about or related to individuals, which provide intuitive graphical information based on characteristics of objects in the display.

2. Description of the Related Art

Many online surveys and personality websites provide questionnaires to compile data on a person, business or other entity. Once completed the results are displayed as text in a formatted manner. These results are often difficult to read quickly and are often complex to the point that merely perusing the profile or results sheet is inadequate.

Further, comparing user's profiles or results is often impossible or difficult since multiple screens are needed or the user needs to go back and forth between the results sheet or profiles. Therefore, it would be advantageous to provide a system and method which enable intuitive interpretation of display information and provides intuitive comparisons between profiles.

### SUMMARY

A system and method for graphically presenting profile data includes providing a plurality of fields on a display, each field representing a different trait. The fields are populated with representative shapes, each shape representing a sub trait where the shape represents a magnitude of the sub trait. The sub trait contributes to an overall value of the trait of that field such that the traits and sub traits collectively provide an entity profile. Graphic modification to the representative shapes is permitted so that a query can be made to find another entity profile with similar graphically depicted traits in accordance with the graphic modification.

A system and method for graphically presenting profile data includes providing a plurality of fields on a display, each field representing a different trait. The fields are populated with a representative shape. Each shape represents a trait or sub trait where the shape represents a magnitude of the trait or sub trait. The traits and sub traits collectively provide an entity profile. Graphic modification to the representative shape permits a comparison with another entity profile with graphically depicted traits in accordance with the graphic modification.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a diagram of a graphical display showing fields and shapes to define a user profile in accordance with one embodiment;

FIG. 2 is a diagram showing a “zoomed in” view of a specific field of FIG. 1 to show more details of a portion of the user profile in accordance with one embodiment;

FIG. 3 is a diagram showing superimposed profiles along with matches for a previous query in accordance with one embodiment;

FIG. 4 is a diagram showing a pop-up element for graphically adjusting shapes in a profile for a new query in accordance with one embodiment;

FIG. 5 is a diagram showing superimposed profiles along with side-by-side comparisons of traits between a reference profile and a matched profile in accordance with one embodiment;

FIG. 6 is a diagram showing superimposed profiles along with side-by-side comparisons of traits between a reference profile and a matched profile and a graphic element for showing relative positions of the respective traits in accordance with one embodiment;

FIG. 7 is a diagram of a graphical display showing fields and shapes in the form of analog meter elements and an equalizer display for a musical preference map in accordance with one embodiment;

FIG. 8 is a diagram showing preference matches for a previous query in accordance with one embodiment;

FIG. 9 is a diagram showing a pop-up element for graphically adjusting bars in the equalizer display to perform a new query in accordance with one embodiment;

FIG. 10 is a diagram showing graphical side-by-side comparisons of traits between a reference profile and a matched profile in accordance with one embodiment;

FIG. 11 is a diagram showing side-by-side comparisons of traits between a reference profile and a matched profile and a graphic element for showing relative positions of the respective traits in accordance with one embodiment; and

FIG. 12 is a block/flow diagram showing a system/method for graphically displaying profile data and permitting graphical querying in accordance with the present principles.

### DETAILED DESCRIPTION OF PREFERRED EMBODIMENTS

In accordance with the present principles, quantitative data representing characteristics of an entity are displayed in a way that is easy to understand and interpret. In particularly useful embodiments, display screens associated with web applications or database queries are contemplated. The display screens provide intuitive and useful information regarding traits of characteristics of an entity or entities. The entities may include an individual, a social group, a business organization, or any other entity.

In one example, users take surveys in different domains like personality, media/music preferences, career, management style, parenting style, vocational interests, avocational interests, values, beliefs, brand personality, etc. Scores or results that are generated upon completion of the survey or through other means may include scores of different traits. For example, traits may include hands-on/off (management style), extraversion/introversion and agreeableness/disagreeableness (personality), loud, aggressive, instrumental (music preferences), etc.

Users are then presented with a visual component that permits the users to perform tasks on their own profiles, on other users' profiles or both. This may include viewing personal results and navigating through these results in greater depth, e.g., zoom into groups of traits for a more detailed breakdown, receive explanations on the different traits, etc.

In another application, one user's results can be compared graphically to someone else's results, for example, compare the most distinctive traits of both individuals, contrast—which traits are the most similar and which are the most different between the two individuals or make any other comparisons.

In still other applications, searches of/for other users may include searching for users who are the most similar to one's traits within the entire pool of users, searching for users who are similar to a person who is a modified version of traits, for example, “people like John” only more sociable, much friendlier, and less emotional (personality); “people like John”, but who like music that is less aggressive and more vocal.

These profiles and comparisons are graphically generated and displayed. The displayed features are fully interactive and can be modified to pose a query, and can be compared graphically These properties of a visual display will illustratively be described with reference to survey results, and interaction paths in a user experience that the graphics drive.

Embodiments in accordance with present principles may take the form of an entirely hardware embodiment, an entirely software embodiment or an embodiment including both hardware and software elements. In a preferred embodiment, the present invention is implemented in software, which includes but is not limited to firmware, resident software, microcode, etc.

Furthermore, the present embodiments can take the form of a computer program product accessible from a computer-usable or computer-readable medium providing program code for use by or in connection with a computer or any instruction execution system. For the purposes of this description, a computer-usable or computer readable medium can be any apparatus that may include, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

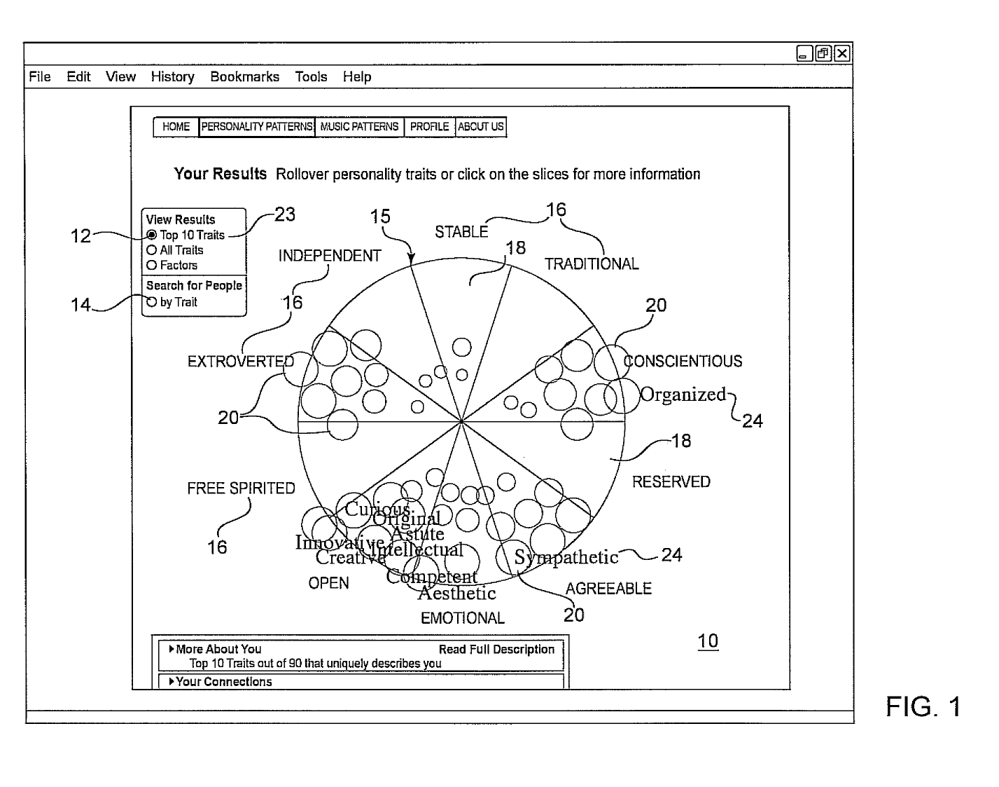

Referring now to the drawings in which like numerals represent the same or similar elements and initially to FIG. 1, a display screen 10 graphically shows the results of a user survey. The survey gathered information about a user's personality traits although any other topic or traits may be employed. In the illustrative example shown, a circle or wheel 15 is divided into portions 18. Each portion represents a general personality trait. These traits may include, e.g., independent, stable, traditional conscientious, reserved, agreeable emotional, open, free-spirited, empowered, etc. Opposing portions 18 may have opposite traits for example, the opposite of independent would be agreeable.

Inside each portion 18 are shapes or objects 20. Each object 20 represents a subset of each general personality trait category. For example, in the agreeable portion 18, a circle is labeled sympathetic 24 to indicate that magnitude of this person's sympathy score. The size of the circle 20 provides a relative score value for that subset trait. The labels 24 are activated by selecting a “top ten traits” item 23 in a view results panel 12. In this way, the ten most dominant subset traits 20 are displayed. Other options may also be made available, e.g., display all traits 24, display all factors (shapes 20). Shapes 20 may have different colors or textures to represent other features or to distinguish from shapes 20 in other sectors 18. Advantageously, based upon the density of and size of shapes 20 in each sector 18 of wheel 15, a user can instantaneously obtain valuable information about an entity.

It should be understood that that only traits and not sub traits may be employed in providing a profile, conducting queries or providing any other functions as described herein.

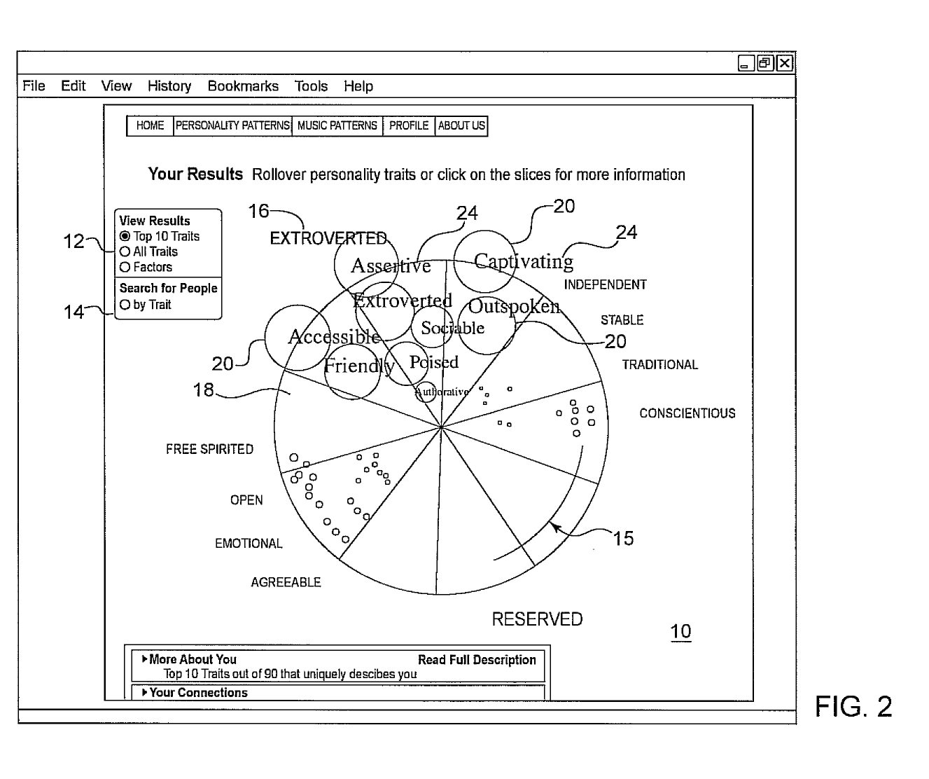

Referring to FIG. 2, individual profile results can be displayed in greater detail by selecting an area of the screen 10 where more information is desired. For example, FIG. 2 shows a user's selection of the extroverted traits 16. Shapes 20 showing sub traits are automatically labeled 24 and the sector is expanded to show details of all sub traits in the sector 18. Further zooming in is permitted using standard zooming tools.

Searching for other users: After a particular entity's profile is displayed comparisons with other entities can be made. For example, by selecting a “search for people” panel 14, e.g., a search by trait or other search type can be performed. Such comparisons may be made without performing a search. For example, two known profiles may be compared or a personal profile can be compared to any other profile. A comparison between two individuals does not have to follow search. For example, a user can find a person to compare with by using a known connection (e.g., use Facebook profile) or by browsing profiles randomly.

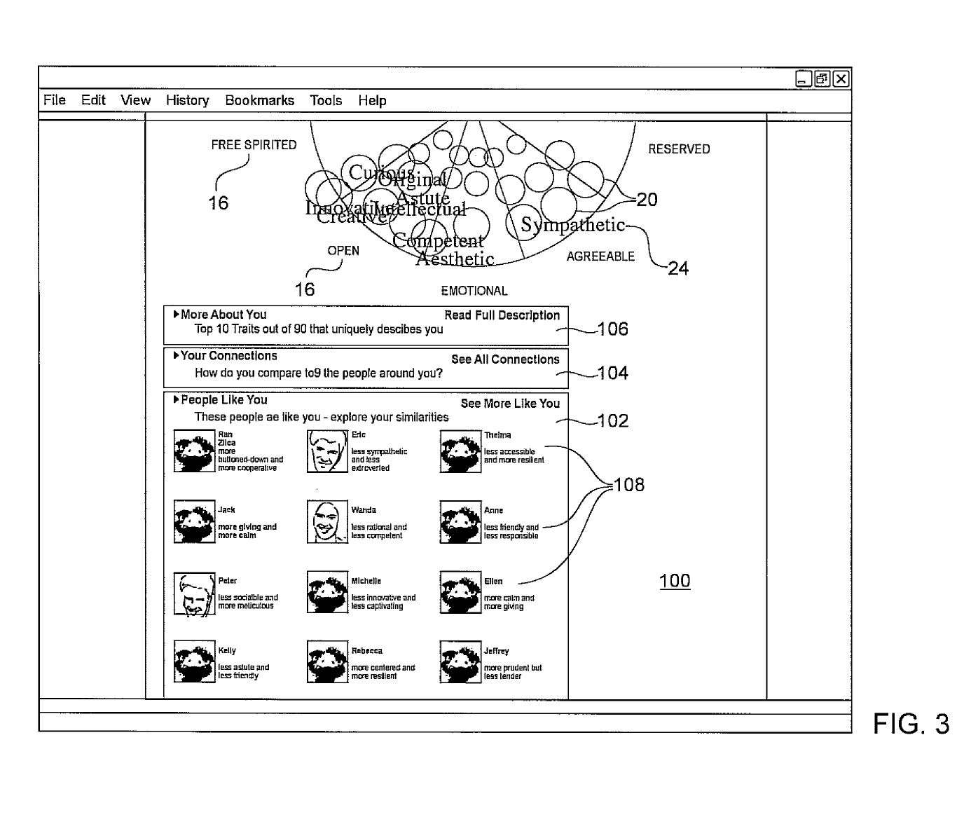

Referring to FIG. 3, in one embodiment, given a profile, a search or comparison may be performed to find other profiles that are similar. Similarity may be measured by scores for the same or similar traits. Tolerances or ranges may be applied to each trait as well. For example, a score of 45-50 may be specified for a given trait. As an alternative, the size and characteristics (e.g., color, texture, etc.) may be employed directly as the criteria for comparison using, for example, a pattern recognition score. Such systems are employed in face recognition and fingerprint recognition systems.

In accordance with the present embodiment, users can search for users/profiles like themselves or users/profiles like a particular profile or selected user. For example, a user may graphically create an imaginary profile and search for similar profiles. In another example, a user may select John Wayne's profile and search for similar profiles. This in general can be referred to as Query By Example (QBE) of people. The concepts of QBE are discussed in U.S. Ser. No. 11/581,051, entitled “SYSTEM AND METHOD FOR CREATING AND USING PERSONALITY MODELS FOR USER INTERACTIONS IN A SOCIAL NETWORK”, filed on Oct. 13, 2006, and U.S. Ser. No. 11/888,974, entitled “SYSTEM AND METHOD FOR IDENTIFYING COMPATIBILITY BETWEEN USERS FROM IDENTIFYING INFORMATION ON WEB PAGES”, filed on Aug. 3, 2007, both incorporated herein by reference.

When a QBE is initiated, a display screen 100 may show a panel 102 showing all of the closest matches 108. Matches 108 may include links to other profiles, thumbnails of pictures, text description, other information or any combination thereof. Display screen 100 may also include other panels 104 and 106 which may be used for other networking or information functions, for example, returning to a personal profile 106 (“more about you”), showing comparisons to other 104 (“your connections”), etc.

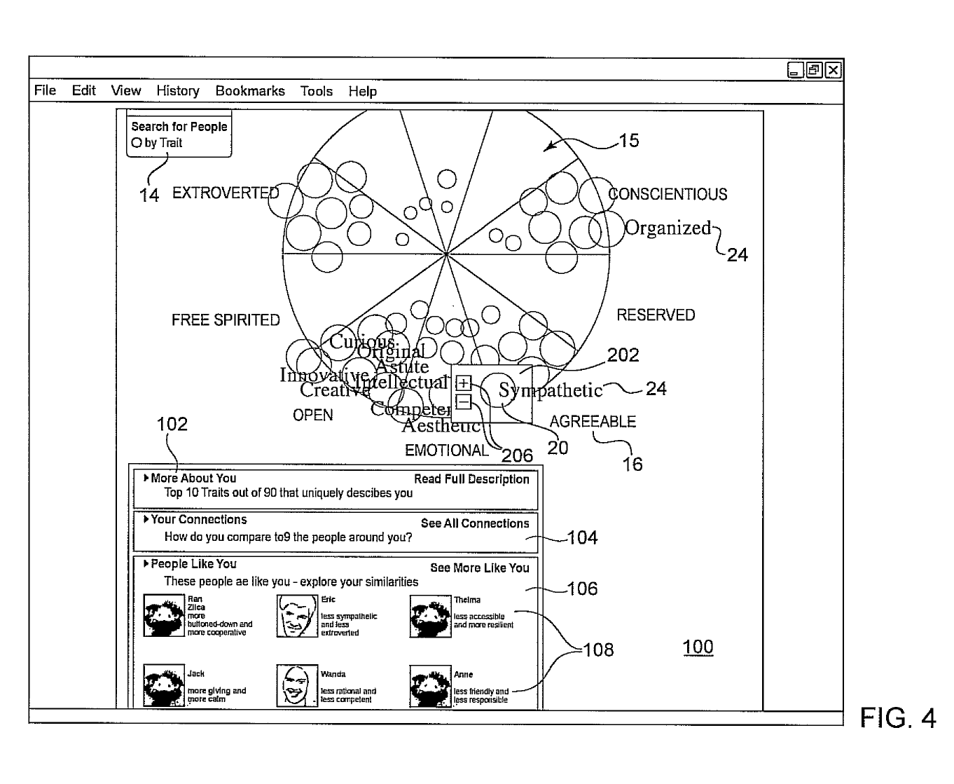

Referring to FIG. 4, setting up a query may include making adjustments to individual traits or sub traits. Once the search by trait panel 14 is activated, a user can select any shape 20 to cause a pop-up element 202 to present itself. The element 202 includes an adjustment mechanism 206 illustratively shown as up and down controls. These controls can be used to increase or decrease the size of the shape 20 to permit adjustment to the query used for searching by trait. In this case, the sympathetic traits (24) are selected and increased. The user desires a profile to match where the profile represents a person with more (or less) sympathetic tendencies.

These adjustments are available for all the traits and sub traits. An entire sector's score may likewise be adjusted as an overall adjustment. This may have the effect of proportionally increasing or decreasing all of the shapes in the sector 18 to achieve the adjusted score. This can be done automatically or the user may adjust the shapes 20 (and even the colors or textures) in accordance with their preferences (e.g., to set up query information).

The query is than implemented and returns the closest or the best matches 108 in accordance with the modified graphics of the initially selected profile.

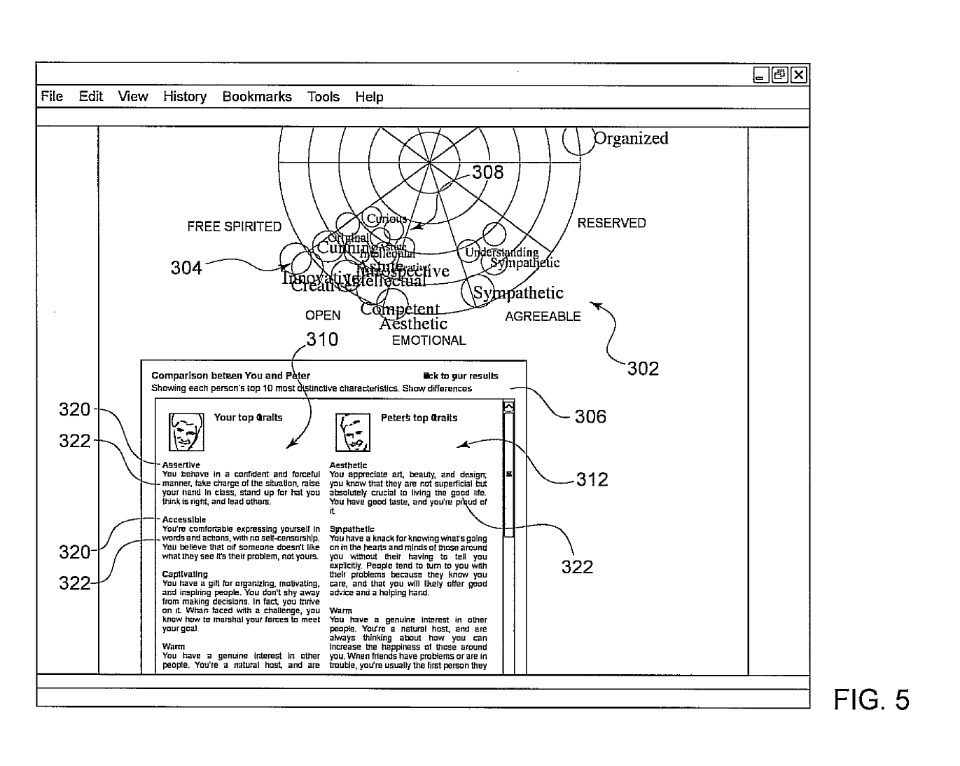

Referring to FIG. 5, after the query has been executed, a “people like you” panel 106 (FIG. 4) is displayed. By selecting one of the matches 108, one or more reports can be selected and presented. First, a graphical comparison 302 is provided. Graphical comparison 302 provides an overlay of the initial query graphic 304 (e.g., the initial profile or modified profile) with the selected matches profile 308 overlaid thereon. In this way, an instantaneous visual comparison can be made between two profiles.

A comparison panel 306 may be provided, which provides a side-by side comparison of traits between a reference profile 310 and a queried profile 312 (matched profile). Each profile may display a portion or all of the traits 320, and a brief textual description 322 of each. Each profile may include other information as well, for example, a picture of the entity or person represented by the profile, a motto, a name, etc.

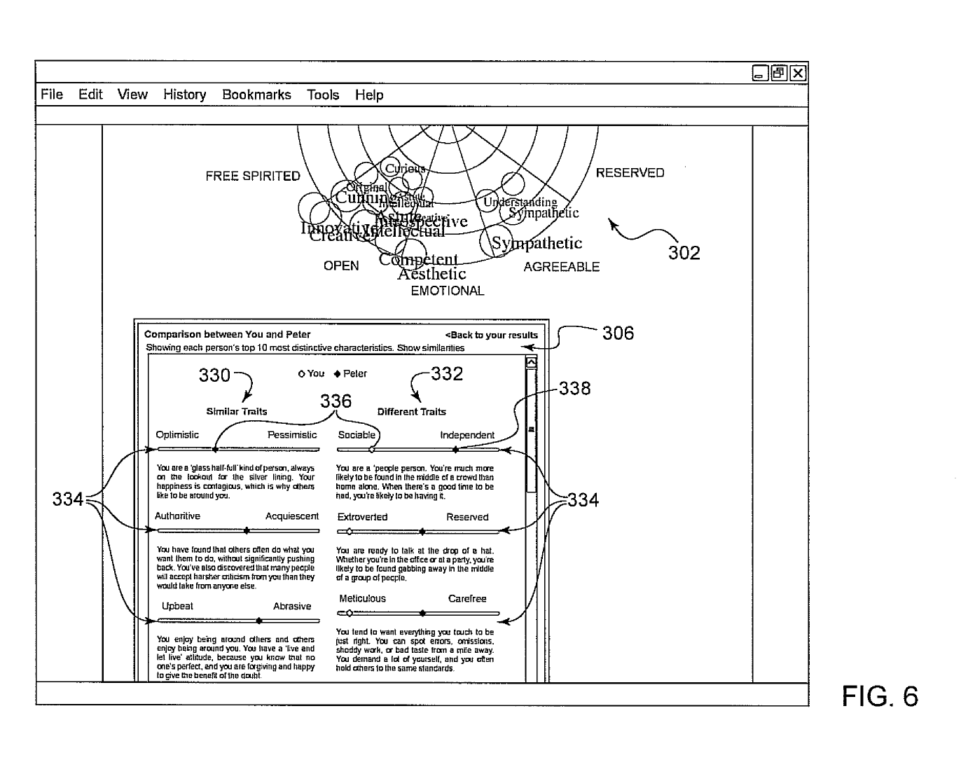

Referring to FIG. 6, the comparison panel 306 may also provide an analysis or comparison between most similar traits 330 and most different traits 332 (or all traits, if desired). This provides a side-by side comparison of traits between the reference profile and the queried profile (matched profile). Each trait or trait pair may include a graphic 334 such as a bar (or pie chart, bar graph etc.) with indicators 336 and 338 that represent where in a scale of the bar each profile score exists.

The present principles may be directed to other interfaces and other graphical applications as well. In addition to profiles or representations of entities, a user's or entity's preferences may be mapped out and used to find other preference maps that are the same, similar or modified as set forth above for profiles. For example, information collections for vocational interests, avocational interests, values and beliefs, parenting style, media/genre preferences, brand personality, etc. may be provided and employed. An illustrative example of a music preference map for an individual will now be employed to explain another exemplary embodiment.

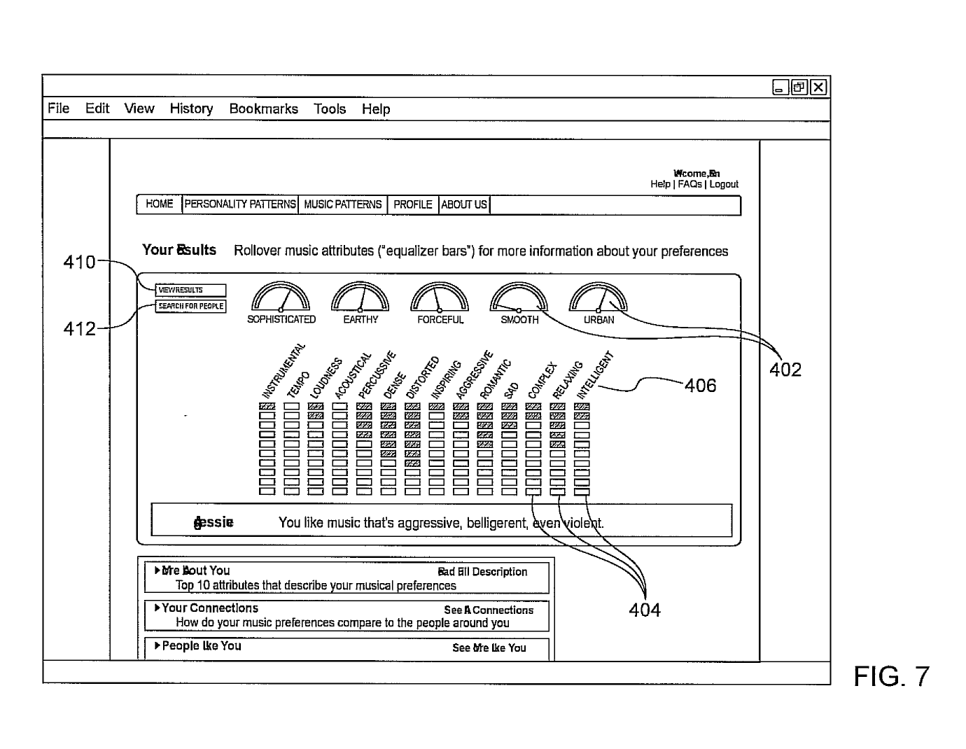

Referring to FIG. 7, a display screen 400 shows the results of a music survey conducted by a user. The survey may include a questionnaire or the exposure of the user to music selections to rate or otherwise score the selections. The user's results are mapped out into categories 402. These may include, e.g., sophisticated, earthy, forceful, smooth, urban etc. The categories 402 by further broken down into sub categories, or in the case depicted, music attributes 406 may be employed to provide additional specifics for music preferences. In the illustrative embodiment, the attributes may include instrumental, tempo, loudness, acoustical, percussive, dense, distorted, inspiring, aggressive, romantic, sad, complex, relaxing, intelligent, etc. as indicated by labels 406.

A user can view their preferences by selecting a “view results” control 410. Advantageously, the user's results are graphically displayed as analog meters for categories 402 and “equalizer-like” displays for attributes 404.

If a user decides to user their own preference map, a modified version of their preference map, someone else's preference map or a modified version of someone else's preference map, the user can select search for people 412.

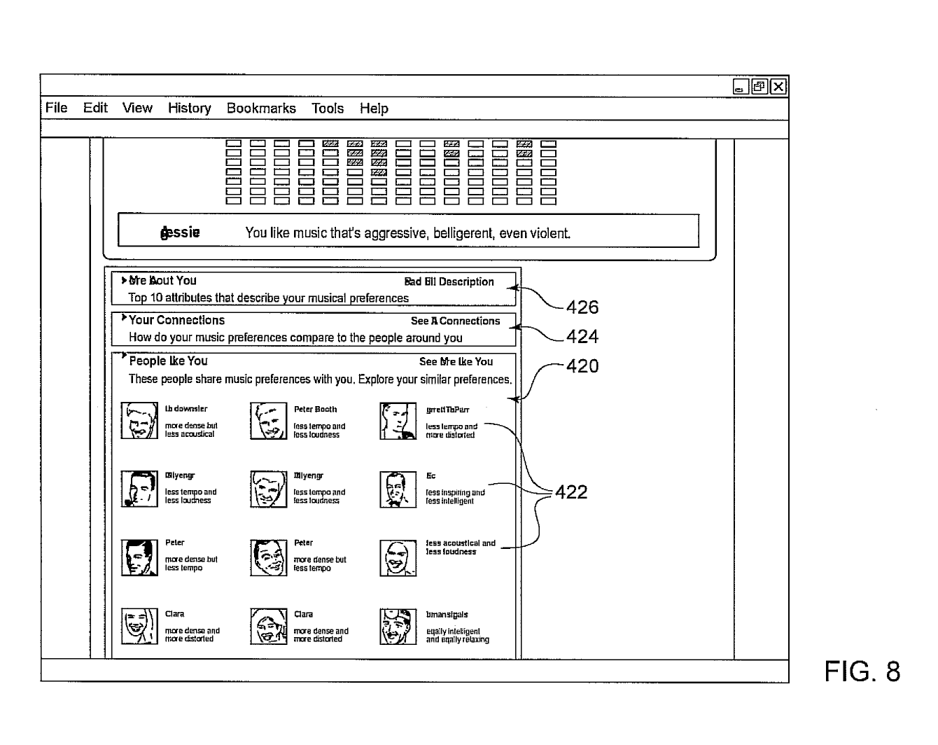

Referring to FIG. 8, if a user decides to user their own preference map or a preference map of someone else, a query can be initiated to find similar preference maps. This may be performed by doing a database search, searching the web or by using other searching techniques. As before, a “people like you” panel 420 is generated where matches 422 are provided. Matches 422 may include tags, names thumbnails, etc. for matching preference maps of others. These matches 422 may then be selected to provide further details of the corresponding preference map of to link to a location related to the match.

The user may return to his/her preference map by selecting panel 426, or may look at friends or “buddy” information by selecting panel 424.

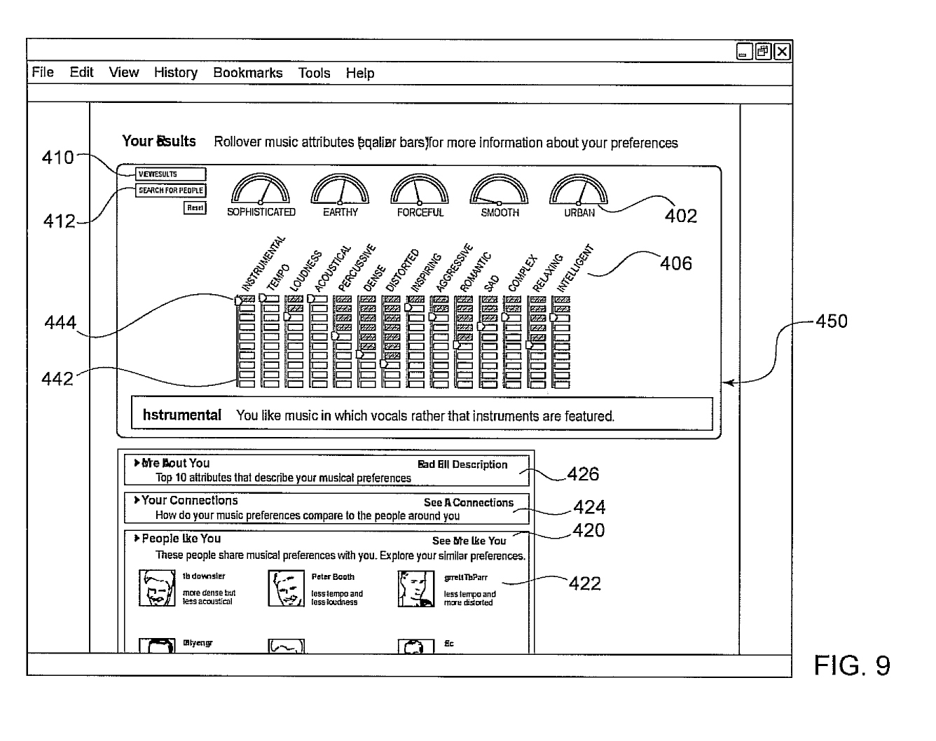

Referring to FIG. 9, when selecting the search for people button 412, the user may modify the attribute settings in the attribute bars 442 to locate a user with different attribute settings. An arrow 444 or other graphical indicator is set to a position or otherwise moved to create a new setting. In this way, the new setting will permit the search to use the new setting or settings. As indicated in FIG. 9, the instrumental category (442) has been reduced from its position in FIG. 7. A new search can now be performed using the new settings.

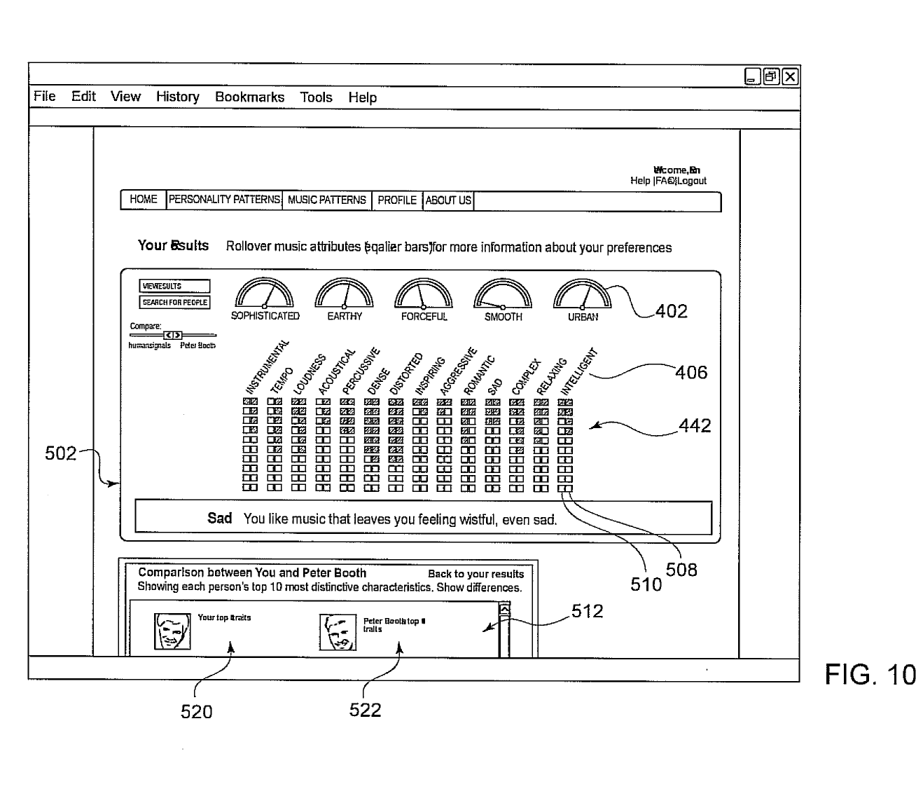

Referring to FIG. 10, after a query has been executed, a panel with matches can be displayed as before. By selecting one of the matches 422, one or more reports can be selected and presented. First, a graphical comparison 502 is provided. Graphical comparison 502 provides a side-by-side comparison between an initial query graphic 510 for each attribute (e.g., the initial profile or modified profile) with the selected matched profile 508 attributes. In this way, an instantaneous visual comparison can be made between two profiles.

A comparison panel 512 may be provided, which provides a side-by side comparison of traits between a reference profile 520 and a queried or selected profile 522 (e.g., matched profile), as before. Each profile may display a portion or all of the preferences, and a brief textual description of each. Each preference map may include other information as well, for example, a picture of the entity or person represented by the profile, a motto, a name, etc.

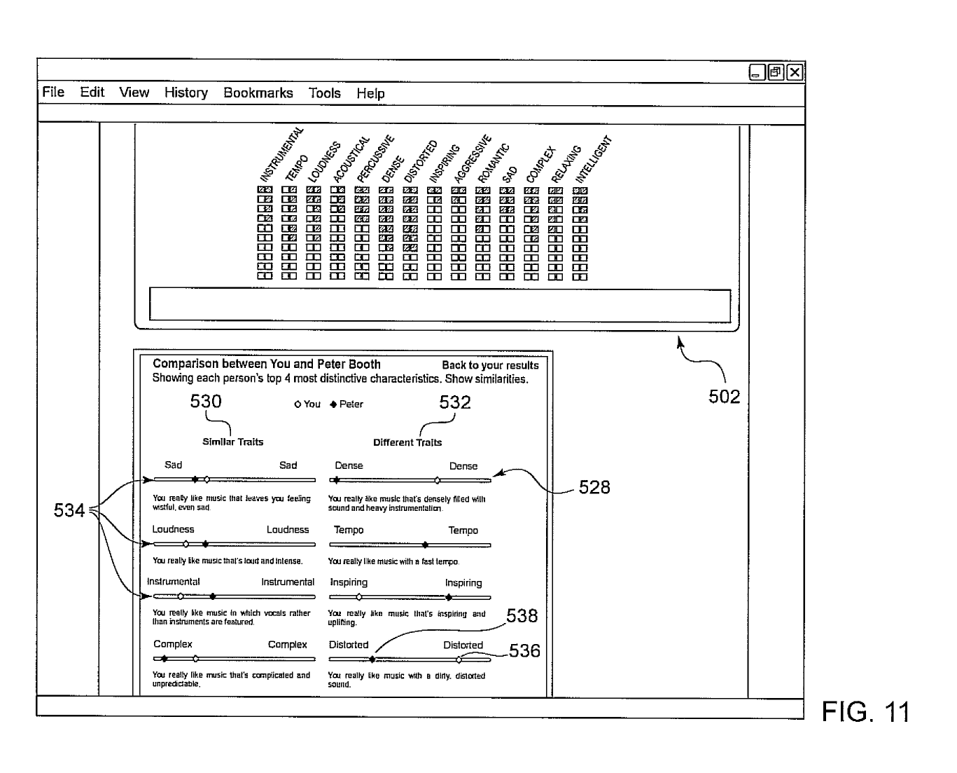

Referring to FIG. 11, a comparison panel 528 may also provide an analysis or comparison between most similar traits 530 and most different traits 532 (or all traits or preferences, if desired). This provides a side-by side comparison of traits between the reference and the queried preference map (matched profile). Each trait or trait pair may include a graphic 534 such as a bar (or pie chart, bar graph etc.) with indicators 536 and 538 that represent where in a scale of the bar each preference score exists with the respective maps.

The present principles may be directed to other interfaces and other graphical applications as well. In addition to profiles or representations of entities, a user's or entity's preferences may be mapped out and used to find other preference maps that are the same, similar or modified as set forth above for profiles.

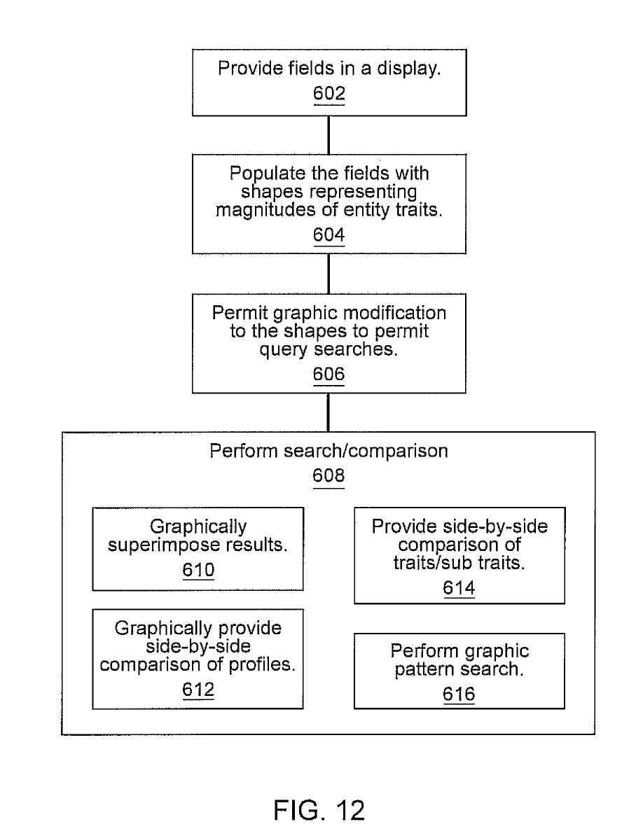

Referring to FIG. 12, a system/method for graphically presenting profile data is illustratively shown. In block 602, a plurality of fields is provided on a display. Each field represents a different trait or attribute. In one embodiment, a circle is provided and the plurality of fields includes sectors of the circle. Each sector represents a different personality trait. In another embodiment, analog meter graphics represent a preference level for a musical attribute. In addition or instead of the analog meters, an equalizer display may be provided, and the plurality of fields includes segmented bar columns where the segmented bars columns indicate a preference level for a musical attribute. Other display effects may also be employed.

In block 604, the fields may be populated with one or more representative shapes or may simply employ a shape to represent traits. Each shape represents a sub trait (or trait) where the shape represents a magnitude of the sub trait (or trait). Sub traits can contribute to an overall value of the trait of that field such that the traits and sub traits collectively provide an entity profile. The fields may include sectors such that opposite personality traits are disposed on directly opposite sides of the circle. The shapes may represent a personality sub trait value by its size. The fields may include bar segment columns with bars where a number of bars represents a preference for a musical attribute.

In block 606, graphic modification is permitted to the representative shapes to permit a query or comparison to find/compare another entity profile with graphically depicted traits in accordance with the graphic modification. A graphic control element is employed to adjust sizes of shapes to permit adjustment to the query or comparison. The graphic control element may be employed to adjust the number of bars in a bar segment column in an equalizer display to permit adjustment to the query/comparison.

In block 608, a search or comparison is performed, and results are output. In block 610, query or comparison results are graphically provided by superimposing two or more graphic profiles on the display. Alternately or in addition, in block 612, query or comparison results are graphically provided by providing a side-by-side comparison of two or more graphic profiles on the display. In addition, in block 614, a side-by-side comparison of two or more profiles where traits or sub traits of each profile are displayed next to one another may be provided. A common graphical element may also be employed with an indicator showing a position for each profile. In an alternate embodiment, a search may be performed based upon a graphic pattern represented by the shapes in block 616.

Having described preferred embodiments of a system and method for efficiently displaying score information related to entities (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims. Having thus described aspects of the invention, with the details and particularity required by the patent laws, what is claimed and desired protected by Letters Patent is set forth in the appended claims.

What is claimed is:

1. A method for graphically presenting profile data, comprising:
providing a plurality of fields on a display, each field representing a different trait;
populating the fields with at least one representative shape, each shape representing a trait or sub trait where the shape represents a magnitude of the trait or sub trait, where the traits and sub traits collectively provide an entity profile; and
permitting graphic modification to the at least one representative shape to permit a comparison with another entity profile with graphically depicted traits in accordance with the graphic modification.

2. The method as recited in claim 1, wherein providing includes providing a circle and the plurality of fields include sectors of the circle, each sector representing a different trait.

3. The method as recited in claim 2, wherein populating the fields includes populating the sectors such that opposite personality traits are disposed on directly opposite sides of the circle.

4. The method as recited in claim 2, wherein populating the fields includes populating the sectors with shapes where each shape represents a personality sub trait by its size.

5. The method as recited in claim 4, wherein permitting graphic modification to the at least one representative shape includes providing a graphic control element to adjust sizes of shapes to permit adjustment to criteria of the comparison.

6. The method as recited in claim 1, wherein providing includes providing analog meter graphics to represent a preference level for a musical attribute.

7. The method as recited in claim 1, wherein providing includes providing an equalizer display and the plurality of fields include segmented bar columns wherein the segmented bars columns indicate a preference level for a musical attribute.

8. The method as recited in claim 6, wherein populating the fields includes populating the bar segment columns with bars where a number of bars represents a preference for a musical attribute.

9. The method as recited in claim 8, wherein permitting graphic modification to the at least one representative shape includes providing a graphic control element to adjust the number of bars to permit adjustment to criteria of the comparison.

10. The method as recited in claim 1, further comprising graphically providing query results by superimposing two or more graphic profiles on the display.

11. The method as recited in claim 1, further comprising graphically providing query results by providing a side-by-side comparison of two or more graphic profiles on the display.

12. The method as recited in claim 1, further comprising graphically providing query results by providing a side-by-side comparison of two or more profiles where traits or sub traits of each profile are displayed next to one another.

13. The method as recited in claim 1, further comprising graphically providing query results by providing a side-by-side comparison of two or more profiles where traits or sub traits of each profile are displayed using a common graphical element with an indicator showing a position for each profile.

14. The method as recited in claim 1, further comprising performing a search based upon a graphic pattern represented by the shapes.

15. The method as recited in claim 1, further comprising graphically providing a side-by-side comparison of two or more profiles where traits or sub traits of each profile are displayed next to one another.

16. The method as recited in claim 1, further comprising graphically comparing two profiles.

17. The method as recited in claim 1, where sub traits contribute to an overall value of the trait of that field.

18. A computer readable medium comprising a computer readable program for graphically presenting profile data, wherein the computer readable program when executed on a computer causes the computer to perform the steps of:
providing a plurality of fields on a display, each field representing a different trait;
populating the fields with at least one representative shape, each shape representing a trait or sub trait where the shape represents a magnitude of the trait or sub trait, where the traits and sub traits collectively provide an entity profile; and
permitting graphic modification to the at least one representative shape to permit a comparison with another entity profile with graphically depicted traits in accordance with the graphic modification.
